(19) United States
(12) Patent Application Publication
(10) Pub. No.: US 2026/0277589 A1
(43) Pub. Date: Sep. 17, 2026

(54) VERSION PRESENTATION DEVICE, VERSION PRESENTATION METHOD, AND RECORDING MEDIUM

(71) Applicant: NEC Corporation, Tokyo (JP)

(72) Inventor: Shumpei MOROHOSHI, Tokyo (JP)

(73) Assignee: NEC Corporation, Tokyo (JP)

(21) Appl. No.: 19/554,801

(22) Filed: Mar. 3, 2026

(30) Foreign Application Priority Data
Mar. 14, 2025 (JP) 2025-041856

(51) Int. Cl. G06F 8/65; G06F 8/71

(52) U.S. Cl. CPC G06F 8/65; G06F 8/71

(57) ABSTRACT

A version presentation device includes one or more memories storing instructions; and one or more processors configured to execute the instructions to: acquire product information, vulnerability information, and defect information; determine an optimal version at time of performing version upgrade among versions of a version upgrade target product by using the product information, the vulnerability information, and the defect information obtained, and information on the version upgrade target product; and present the optimal version determined. Accordingly, the apparatus supports automated decision making on optimal version selection by utilizing advanced AI techniques.

### CROSS-REFERENCE TO RELATED APPLICATION

This application is based upon and claims the benefit of priority from Japanese Patent Application No. 2025-041856, filed on Mar. 14, 2025, the disclosure of which is incorporated herein in its entirety by reference.

### TECHNICAL FIELD

The present disclosure relates to a version presentation device, a version presentation method, and a recording medium.

### BACKGROUND ART

For example, JP 2015-165363 A describes that a version is selected based on a support period of a module.

### SUMMARY

An example of an object of the present disclosure is to provide a version presentation device, a version presentation method, and a program that can solve the above-described problem.

According to a first aspect of the present disclosure, a version presentation device includes an information acquisition means for acquiring product information, vulnerability information, and defect information, a determination means for determining an optimal version at time of performing version upgrade among versions of a version upgrade target product by using the product information, the vulnerability information, and the defect information obtained, and information on the version upgrade target product, and a presentation means for presenting the optimal version determined.

According to a second aspect of the present disclosure, a version presentation method includes, by a computer, acquiring product information, vulnerability information, and defect information, determining an optimal version at time of performing version upgrade among versions of a version upgrade target product by using the product information, the vulnerability information, and the defect information obtained, and information on the version upgrade target product, and presenting the optimal version determined.

According to a third aspect of the present disclosure, a program causes a computer to execute acquiring product information, vulnerability information, and defect information, determining an optimal version at time of performing version upgrade among versions of a version upgrade target product by using the product information, the vulnerability information, and the defect information obtained, and information on the version upgrade target product, and presenting the optimal version determined.

### BRIEF DESCRIPTION OF THE DRAWINGS

FIG. 1 is a diagram illustrating an example of a configuration of a version presentation device according to at least one example embodiment;

FIG. 2 is a diagram illustrating an example of a procedure of processing in which the version presentation device according to at least one example embodiment receives registration of product information;

FIG. 3 is a diagram illustrating an example of input and output in a case where the version presentation device according to at least one example embodiment performs version selection;

FIG. 4 is a diagram illustrating a first example of a relationship between a scheduled version upgrade date and a version of a version upgrade target product in at least one example embodiment;

FIG. 5 is a diagram illustrating a second example of the relationship between the scheduled version upgrade date and the version of the version upgrade target product in at least one example embodiment;

FIG. 6 is a diagram illustrating a third example of the relationship between the scheduled version upgrade date and the version of the version upgrade target product in at least one example embodiment;

FIG. 7 is a diagram illustrating an example of a procedure of processing in which the version presentation device according to at least one example embodiment performs presentation of a version with respect to a relationship between a current version and a scheduled version upgrade date;

FIG. 8 is a diagram illustrating an example of versions of the version upgrade target product in at least one example embodiment;

FIG. 9 is a diagram illustrating an example in which a determination unit according to at least one example embodiment excludes a version of which a scheduled version upgrade date is not included in a support period;

FIG. 10 is a diagram illustrating an example in which the determination unit according to at least one example embodiment excludes a version having defect information or vulnerability information;

FIG. 11 is a diagram illustrating an example of versions of a related product in at least one example embodiment;

FIG. 12 is a diagram illustrating an example of a product information registration screen according to at least one example embodiment;

FIG. 13 is a diagram illustrating an example of a version upgrade target product information input screen according to at least one example embodiment;

FIG. 14 is a diagram illustrating an example of display of a version selection result by a display unit according to at least one example embodiment;

FIG. 15 is a diagram illustrating an example of the display of the version selection result by the display unit in a case where there is a related product, according to at least one example embodiment;

FIG. 16 is a diagram illustrating a display example of an optimal version by the display unit in a case where there is no version newer than the current version according to at least one example embodiment;

FIG. 17 is a diagram illustrating a display example of the optimal version by the display unit in a case where there is a version newer than the current version and there is no vulnerability information and no defect information according to at least one example embodiment;

FIG. 18 is a diagram illustrating a display example of the optimal version by the display unit in a case where there is no version that is newer than the current version and that has no vulnerability information and no defect information according to at least one example embodiment;

FIG. 19 is a diagram illustrating a display example of a processing result (list of candidates for version upgrade) by the display unit in a case where there is no version newer than the current version according to at least one example embodiment;

FIG. 20 is a diagram illustrating a display example of the processing result by the display unit in a case where there is a version that is newer than the current version and whose version upgrade period is included within the support period according to at least one example embodiment;

FIG. 21 is a diagram illustrating an example of acquisition of information by the version presentation device according to at least one example embodiment;

FIG. 22 is a diagram illustrating an example of a configuration of a version presentation device according to at least one example embodiment;

FIG. 23 is a diagram illustrating an example of processing in a version presentation method according to at least one example embodiment; and

FIG. 24 is a diagram illustrating an example of a configuration of a computer according to at least one example embodiment.

### EXAMPLE EMBODIMENT

Hereinafter, example embodiments will be described with reference to the drawings.

### First Example Embodiment

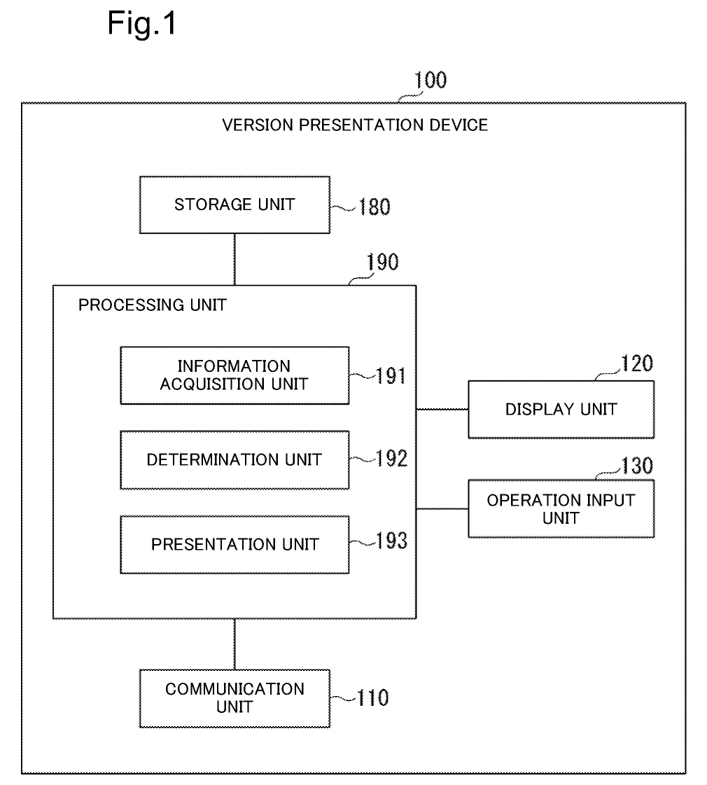

FIG. 1 is a diagram illustrating an example of a configuration of a version presentation device according to at least one example embodiment. In the configuration illustrated in FIG. 1, a version presentation device 100 includes a communication unit 110, a display unit 120, an operation input unit 130, a storage unit 180, and a processing unit 190. The processing unit 190 includes an information acquisition unit 191, a determination unit 192, and presentation unit 193.

The version presentation device 100 proposes, for example, a version in a case where version upgrade is performed for a product that can be a target of defect information and vulnerability information, such as an ICT product. A product as a target for which the version presentation device 100 proposes a version is also referred to as a version upgrade target product.

The product herein can include various products that can be targets of the defect information and the vulnerability information. For example, the product herein may be hardware, software, or a combination of hardware and software.

The communication unit 110 communicates with another device. For example, the communication unit 110 may acquire product information such as version information and defect information on a product from another device. The communication unit 110 may acquire defect information on a product from another device.

The display unit 120 has a display screen such as a liquid crystal panel or a Light Emitting Diode (LED) panel, for example, and displays various images. For example, the display unit 120 may display a version selection result (proposed version) by the version presentation device 100.

The operation input unit 130 includes, for example, an input device such as a keyboard and a mouse, and receives a user operation. For example, the operation input unit 130 may receive a user operation of inputting information regarding the version upgrade target product.

In addition to or instead of the communication unit 110 receiving the version information, the defect information, and the vulnerability information on the product, the operation input unit 130 may receive a user operation of inputting the version information, the defect information, and the vulnerability information on the product.

The storage unit 180 stores various data. For example, the storage unit 180 may store the version information, the defect information, and the vulnerability information on the product. The storage unit 180 may store the information regarding the version upgrade target product. The storage unit 180 is configured using a storage device included in the version presentation device 100.

The processing unit 190 controls each unit of the version presentation device 100 to perform various types of processing. For example, a central processing unit (CPU) included in the version presentation device 100 reads a program from the storage unit 180 and executes the program, whereby a function of the processing unit 190 is executed.

The information acquisition unit 191 acquires various types of information. For example, the information acquisition unit 191 acquires the version information, the defect information, and the vulnerability information on the product, and the information regarding the version upgrade target product.

The information acquisition unit 191 corresponds to an example of an information acquisition means.

The determination unit 192 determines a version to be proposed as a version for performing version upgrade of the version upgrade target product. Determining the version proposed by the determination unit 192 is also referred to as version selection.

The determination unit 192 corresponds to an example of a determination means.

The presentation unit 193 controls the display unit 120 to display various types of information. In particular, the presentation unit 193 causes the display unit 120 to display the version proposed by the version presentation device.

The presentation unit 193 corresponds to an example of a presentation means.

The display by the display unit 120 can be regarded as presentation performed by the presentation unit 193 using the display unit 120.

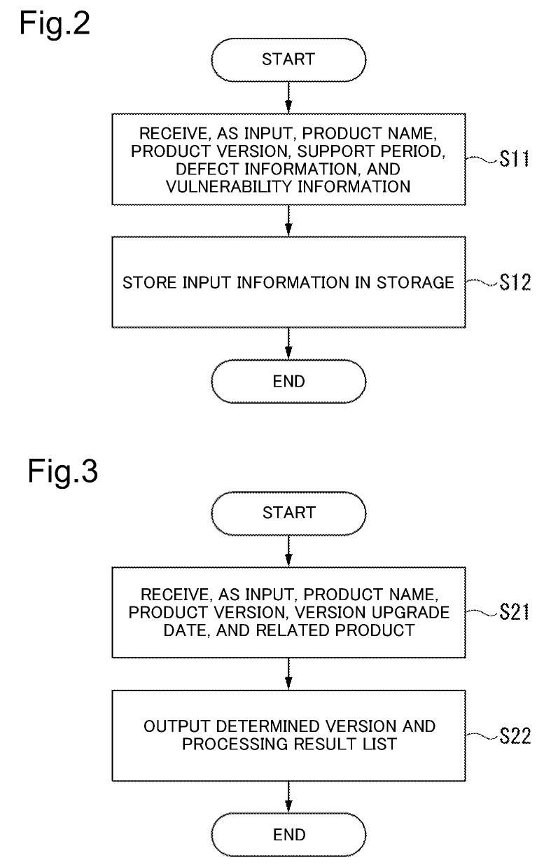

FIG. 2 is a diagram illustrating an example of a procedure of processing in which the version presentation device 100 receives registration of product information.

In the processing in FIG. 2, the operation input unit 130 receives an input operation of a product name, a product version, a support period, defect information, and vulnerability information by an administrator (an administrator of the version presentation device 100) (step S11). As a result, the information acquisition unit 191 acquires the product name, the product version, the support period, the defect information, and the vulnerability information.

Then, the storage unit 180 stores the input information in storage (step S12). Specifically, the information acquisition unit 191 stores the product name, the product version, the support period, the defect information, and the vulnerability information in the storage of the storage unit 180.

After step S12, the version presentation device 100 ends the processing in FIG. 2.

FIG. 3 is a diagram illustrating an example of input and output in a case where the version presentation device 100 performs version selection.

In the processing in FIG. 3, the operation input unit 130 receives an input operation of a product name, a product version, a scheduled version upgrade date, and a related product of a version upgrade target product (step S21).

The related product herein is a product whose usable version is limited according to a version of a certain product such as a version upgrade target product. The fact that, according to a version of one product, a usable version of another product is limited, is also referred to as that the versions of these two products are in a dependency relationship.

In a case where a first product of a version A is used as a first product, if a second product of version B can be used as the second product that is a related product of the first product, it is also referred to that the version A of the first product and the version B of the second product are in a correspondence relationship, or the version B of the second product is relevant to the version A of the first product.

Through the processing in step S21, the information acquisition unit 191 acquires information on the product name, the product version, the scheduled version upgrade date, and the related product of the version upgrade target product.

Then, the version presentation device 100 processes the input information, selects an optimal version, and outputs optimal version information (step S22).

After step S22, the version presentation device 100 ends the processing in FIG. 3.

The version presentation device 100 performs presentation of the version as follows with respect to a relationship between a current version and a scheduled version upgrade date.

(Case 1) In a case where there is no version newer than the current product version, the version presentation device 100 does not perform presentation of the version.

(Case 2) In a case where there is no version newer than the current product version before the scheduled version upgrade date, the version presentation device 100 does not perform presentation of the version.

(Case 3) In a case where there is a version newer than the current product version before the scheduled version upgrade date, the version presentation device 100 presents the version.

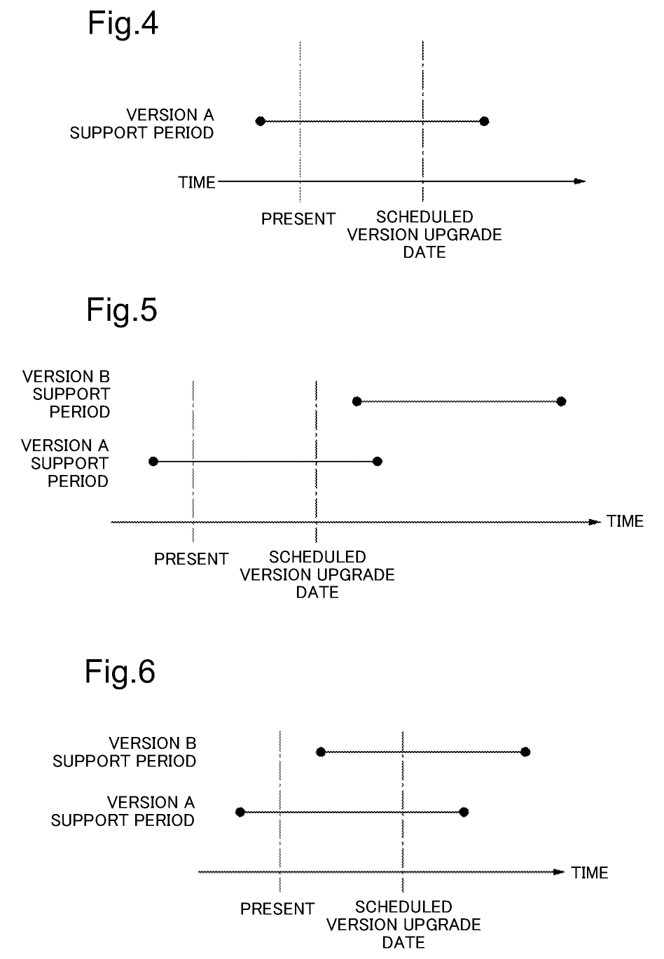

FIG. 4 is a diagram illustrating a first example of a relationship between a scheduled version upgrade date and a version of a version upgrade target product. FIG. 4 illustrates an example of a case corresponding to Case 1 described above.

In the example of FIG. 4, the current version of the version upgrade target product is A. There is no version newer than the version A for the version upgrade target product.

In this case, the latest version on the scheduled version upgrade date is A. The version presentation device 100 therefore does not perform presentation of the version.

FIG. 5 is a diagram illustrating a second example of the relationship between the scheduled version upgrade date and the version of the version upgrade target product. FIG. 5 illustrates an example of a case corresponding to Case 2 described above.

In the example of FIG. 5, the current version of the version upgrade target product is A. For the version upgrade target product, release of the version B newer than the version A is scheduled, but the version B is not released before the scheduled version upgrade date.

Also in this case, the latest version on the scheduled version upgrade date is A. The version presentation device 100 therefore does not perform presentation of the version.

FIG. 6 is a diagram illustrating a third example of the relationship between the scheduled version upgrade date and the version of the version upgrade target product. FIG. 6 illustrates an example of a case corresponding to Case 3 described above.

In the example of FIG. 6, the current version of the version upgrade target product is A. For the version upgrade target product, release of the version B newer than the version A is scheduled before the scheduled version upgrade date.

In this case, the latest version on the scheduled version upgrade date is B. The version presentation device 100 therefore presents the version B.

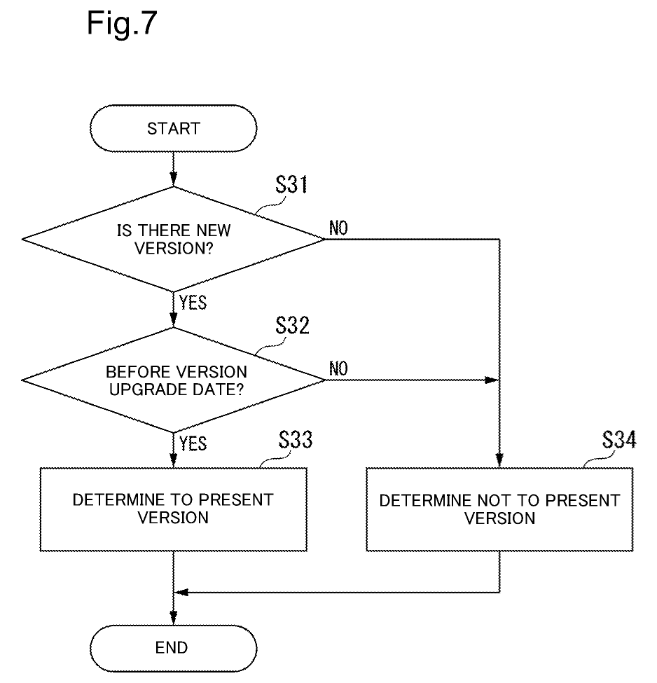

FIG. 7 is a diagram illustrating an example of a procedure of processing in which the version presentation device 100 performs presentation of the version with respect to the relationship between the current version and the scheduled version upgrade date. FIG. 7 illustrates an example of processing by the version presentation device 100 according to Cases 1 to 3 described above.

In the processing in FIG. 7, the determination unit 192 determines whether there is a new version of the version upgrade target product (step S31). That is, the determination unit 192 determines whether release of a version newer than the current version is scheduled for the version upgrade target product.

In a case where it is determined that there is a new version (step S31: YES), the determination unit 192 determines whether there is the new version of the version upgrade target product before the scheduled version upgrade date (step S32). That is, the determination unit 192 determines whether the release of the version newer than the current version is scheduled before the scheduled version upgrade date, for the version upgrade target product.

In a case where it is determined that there is the new version before the scheduled version upgrade date, the determination unit 192 determines to present the version (step S33).

After step S33, the version presentation device 100 ends the processing in FIG. 7.

On the other hand, in a case where it is determined in step S31 that there is no new version (step S31: NO), the determination unit 192 determines not to present a version (step S34).

After step S34, the version presentation device 100 ends the processing in FIG. 7.

In step S32, in a case where the determination unit 192 determines that there is not the new version before the scheduled version upgrade date (step S32: NO), the processing proceeds to step S34.

In a case where it is determined to present the version, the version presentation device 100 performs presentation of the version according to the following procedure.

(Procedure 1) The determination unit 192 arranges versions of the target product in descending order from the latest version.

(Procedure 2) The determination unit 192 excludes a version whose scheduled version upgrade date does not include the support period from candidates for the version upgrade.

(Procedure 3) The determination unit 192 excludes a version having the defect information or the vulnerability information from candidates for the optimal version.

(Procedure 4) The presentation unit 193 presents the optimal version.

(Procedure 5) The presentation unit 193 presents a processing result of version selection.

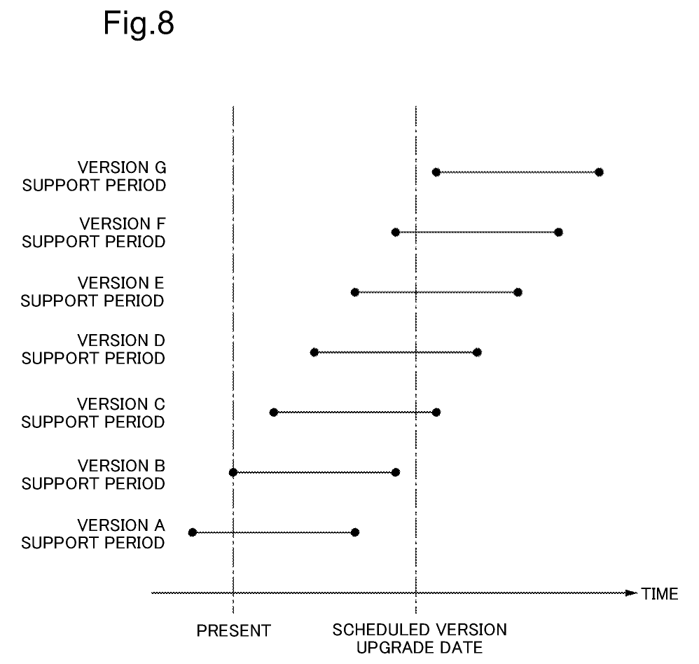

FIG. 8 is a diagram illustrating an example of versions of the version upgrade target product.

In the example of FIG. 8, the versions of the version upgrade target product are versions G, F, E, D, C, B, and A in descending order (in order from the latest version).

In accordance with Procedure 1 described above, the determination unit 192 sets the versions G, F, E, D, C, and B newer than the version A that is the version at the present time as presented versions at the present time, and sets the order of optimal versions at the present time in the order of G, F, E, D, C, and B.

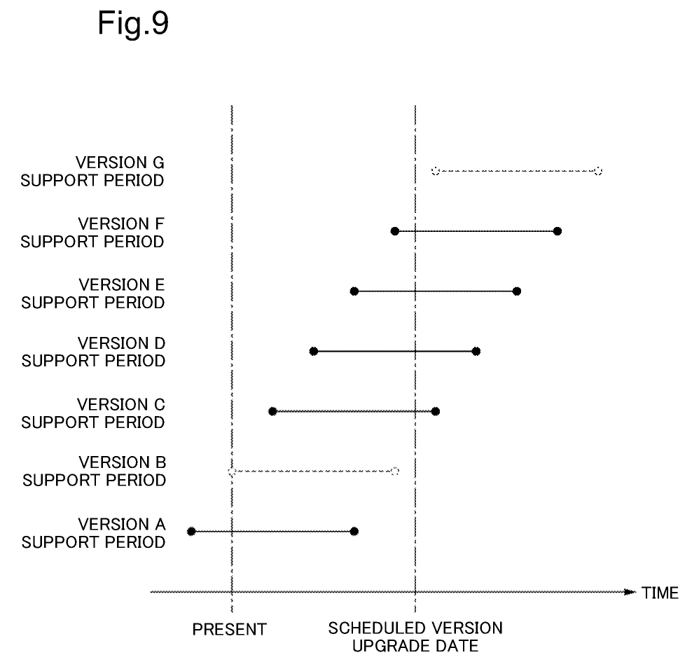

FIG. 9 is a diagram illustrating an example in which the determination unit 192 excludes a version of which a scheduled version upgrade date is not included in the support period. FIG. 9 illustrates an example of a case where the determination unit 192 excludes the version of which the scheduled version upgrade date is not included in the support period from the example of FIG. 8.

In the example of FIG. 9, the support period of the version B ends before the scheduled version upgrade date. The determination unit 192 therefore excludes the version B from the candidates for the version upgrade in accordance with Procedure 2 described above.

The support period of the version G is not started on the scheduled version upgrade date. The determination unit 192 therefore excludes the version G from the candidates for the version upgrade in accordance with Procedure 2 described above.

As a result, the determination unit 192 sets the versions F, E, D, and C as the presented versions at the present time, and sets the order of the optimal versions at the present time in the order of F, E, D, and C.

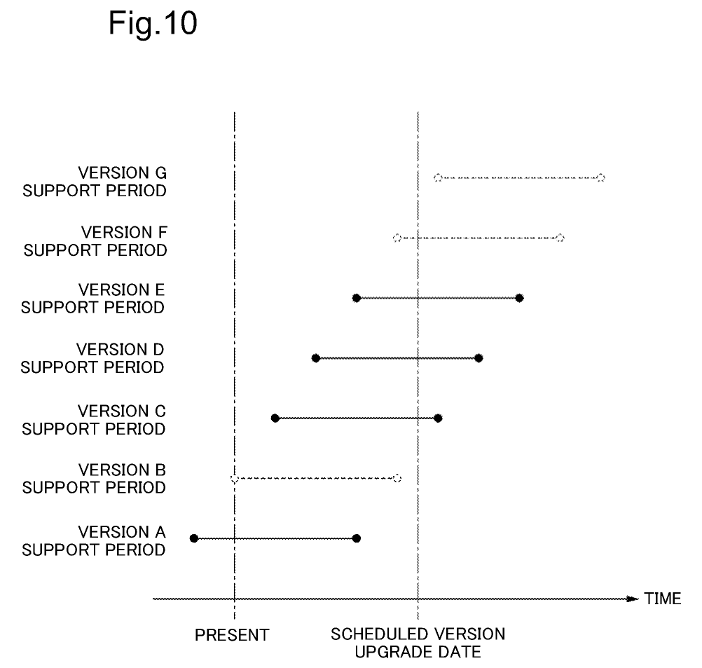

FIG. 10 is a diagram illustrating an example in which the determination unit 192 excludes a version having the defect information or the vulnerability information. FIG. 10 illustrates an example of a case where the determination unit 192 excludes a version having the defect information or the vulnerability information from the example of FIG. 9.

In the example of FIG. 10, it is assumed that the defect information or the vulnerability information is registered in the version F. The determination unit 192 therefore excludes the version F from the candidates for the optimal version in accordance with Procedure 3 described above. On the other hand, the determination unit 192 leaves the version F as a candidate for the version upgrade.

As a result, the determination unit 192 sets the versions F, E, D, and C as the presented versions at the present time, and sets the order of the optimal versions at the present time in the order of E, D, and C.

Alternatively, in a case where a condition as to whether the product is a target of the vulnerability information is indicated, the determination unit 192 may determine whether a product as a version upgrade target is a target of the vulnerability information. Then, only in a case where the determination unit 192 determines that a version is a target of the vulnerability information, the version may be excluded from the candidates for the optimal version.

For example, in a case where the fact that the product includes a certain optional unit is a target of the vulnerability information, the determination unit 192 may determine whether the product as a version upgrade target includes the optional unit.

As for the condition as to whether the product is a target of the vulnerability information, a person may make the condition a rule in a rule-based manner in advance. Then, the determination unit 192 may determine whether the condition is satisfied based on the rule.

Alternatively, the condition may be automatically extracted, for example, by the determination unit 192 extracting the condition from the vulnerability information by using a large-scale language model.

This similarly applies to the defect information.

The presentation unit 193 presents the version E having the highest priority of the optimal version as the optimal version in accordance with Procedure 4 described above.

In addition, the presentation unit 193 presents the versions F, E, D, and C as the candidates for the version upgrade, based on a processing result of the version selection, in accordance with Procedure 5 described above.

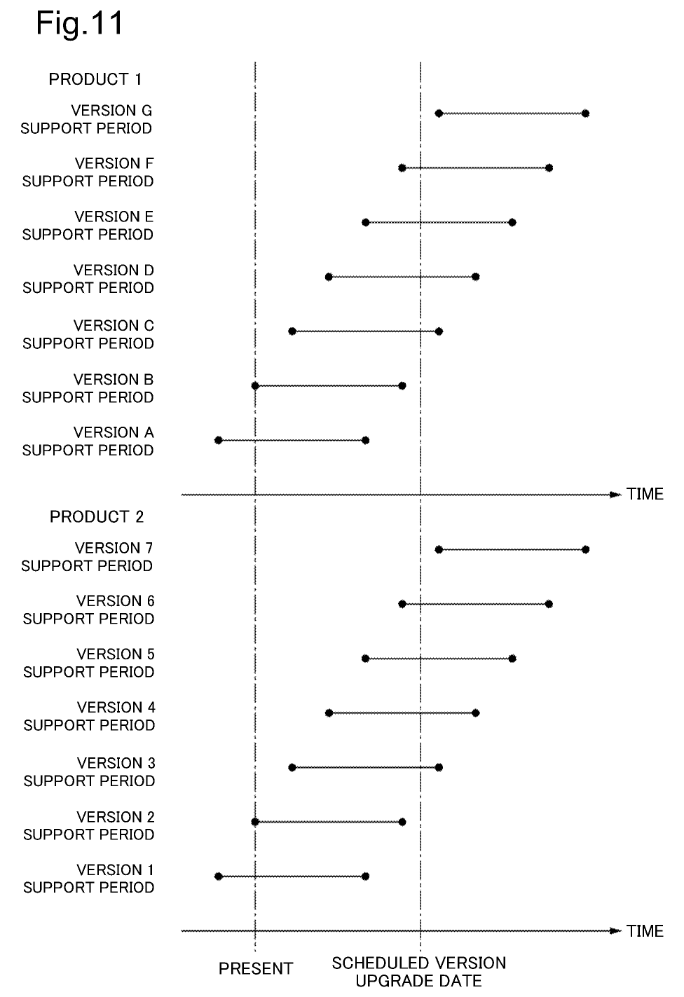

FIG. 11 is a diagram illustrating an example of versions of a related product. In the example of FIG. 11, there is a dependency relationship between a version of a product 1 and a version of a product 2, and in a case where version upgrade is performed for either one of the products 1 and 2, it is assumed that the other version also needs to be considered. For example, it is assumed that the product 1 is a version upgrade target product (product for which version upgrade is desired to be performed) and the product 2 is a related product of the product 1.

In this case, the determination unit 192 performs presentation of the optimal version for both the products 1 and 2.

The determination unit 192 determines the optimal version based on both the version of the product 1 and the version of the product 2. That is, based on a correspondence relationship between the version of the product 1 and the version of the product 2, the determination unit 192 sets, as the candidate for the optimal version, the latest version among combinations of versions in which both the version of the product 1 and the version of the product 2 relevant to the version of the product 1 are included in the candidates for the optimal version.

For example, the determination unit 192 determines, for the related product, a version of which the scheduled version upgrade date is included within the support period as a version of a candidate for version upgrade of the related product, as in Procedures 1 and 2 described above.

Then, the determination unit 192 determines, as the optimal version of the version upgrade target product, a latest version among the versions of the version upgrade target product, the latest version being included in versions of a candidate for the version upgrade of the version upgrade target product and having no vulnerability information and no defect information and having a version of the related product relevant to the latest version, the version being included in versions of the candidate for the version upgrade of the related product and having no vulnerability information and no defect information.

In addition, the determination unit 192 determines, as the optimal version of the related product, a latest version among versions of the related product relevant to the optimal version of the version upgrade target product, the latest version being included in the versions of the candidate for the version upgrade of the related product and having no vulnerability information and no defect information.

On the other hand, in a case where there is no candidate for the optimal version of the related product, the determination unit 192 excludes a corresponding version of the version upgrade target product from the candidates for the optimal version.

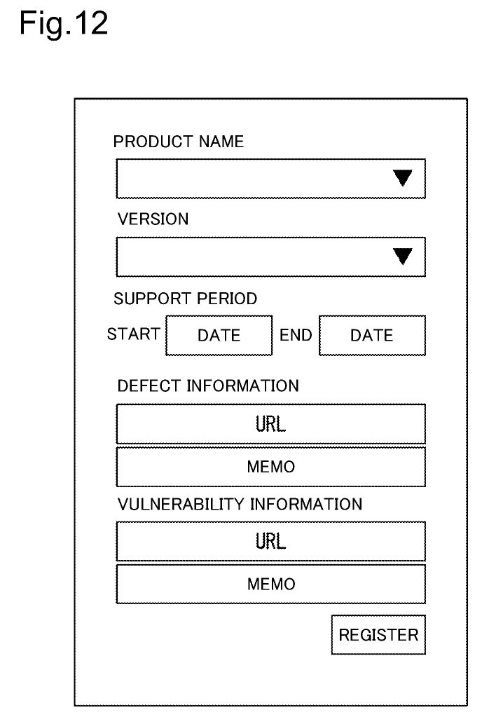

FIG. 12 is a diagram illustrating an example of a product information registration screen. For example, the display unit 120 displays the product information registration screen, and the operation input unit 130 receives a user operation. The administrator inputs the product name, the version information, the support period, the defect information, and the vulnerability information from the product information registration screen.

As for the product name, the display unit 120 may display a list of product names stored in the version presentation device 100 so that the administrator can select a product name from the list. In the case of newly registering a product name, the administrator directly inputs the product name.

As for the version information, the display unit 120 may display a list of versions stored in the version presentation device 100 for the product input in a product name field so that the administrator can select a version from the list. In the case of newly registering a version, the administrator directly inputs the version.

In a case where the support period has already been registered in the version presentation device 100, the display unit 120 automatically displays the support period in accordance with the input of the product name and the version.

In a case where the defect information has already been registered in version presentation device 100, the display unit 120 automatically displays the defect information in accordance with the input of the product name and the version. In a case where a URL of the defect information is registered, the version presentation device 100 treats the defect information as being present.

In a case where the vulnerability information has already been registered in the version presentation device 100, the display unit 120 automatically displays the vulnerability information in accordance with the input of the product name and the version. In a case where a URL of the vulnerability information is registered, the version presentation device 100 treats the vulnerability information as being present.

In a case where there are many product names, a product category field may be provided. Then, the display unit 120 may display a list of product names of a category selected in the product category field.

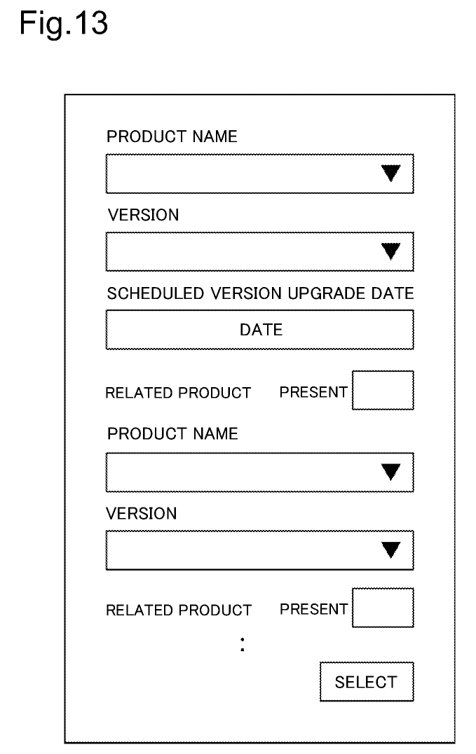

FIG. 13 is a diagram illustrating an example of a version upgrade target product information input screen. For example, the display unit 120 displays the version upgrade target product information input screen, and the operation input unit 130 receives a user operation. A user who wants information on version upgrade inputs information on a product for which version upgrade is desired from the version upgrade target product information input screen.

The user inputs a product name and a current version by selecting the product name and the version from the list in the product name field and a version field.

In addition, the user inputs a scheduled version upgrade date.

In a case where there is a related product of the version upgrade target product, the user performs a mouse click or a touch operation on a related product field to check “related product present”.

Then, the user inputs a product name and a current version name of the related product in a similar method as in the case of the version upgrade target product.

In a case where there is further a related product of the version upgrade target product or the input related product, the user repeats the input of the related product.

In a case where there are many product names, a product category field may be provided. Then, the display unit 120 may display a list of product names of a category selected in the product category field.

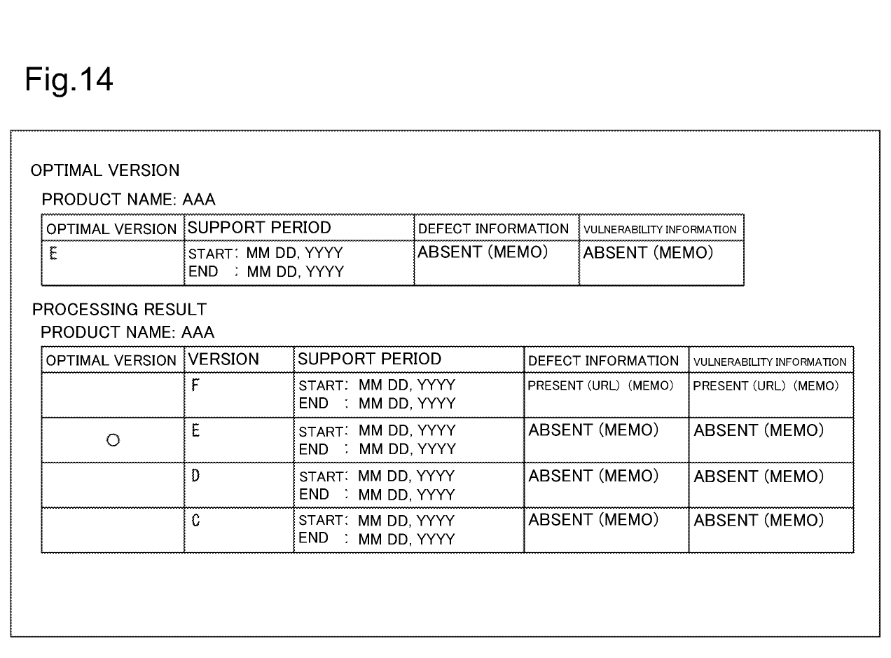

FIG. 14 is a diagram illustrating an example of display of a version selection result by the display unit 120.

The display unit 120 displays the optimal version and versions of the candidate for the version upgrade as an output of the version selection result.

FIG. 14 illustrates an example of display of the version selection result in the example of FIG. 10, and the display unit 120 displays the version E as the optimal version. The display unit 120 displays the support period of the version E, that there is no defect information, and that there is no vulnerability information.

The display unit 120 displays the support period, the defect information, and the vulnerability information on each of the versions F, E, D, and C as a list of candidates for the version upgrade. The display unit 120 displays that the optimal version is the version E in an optimal version field.

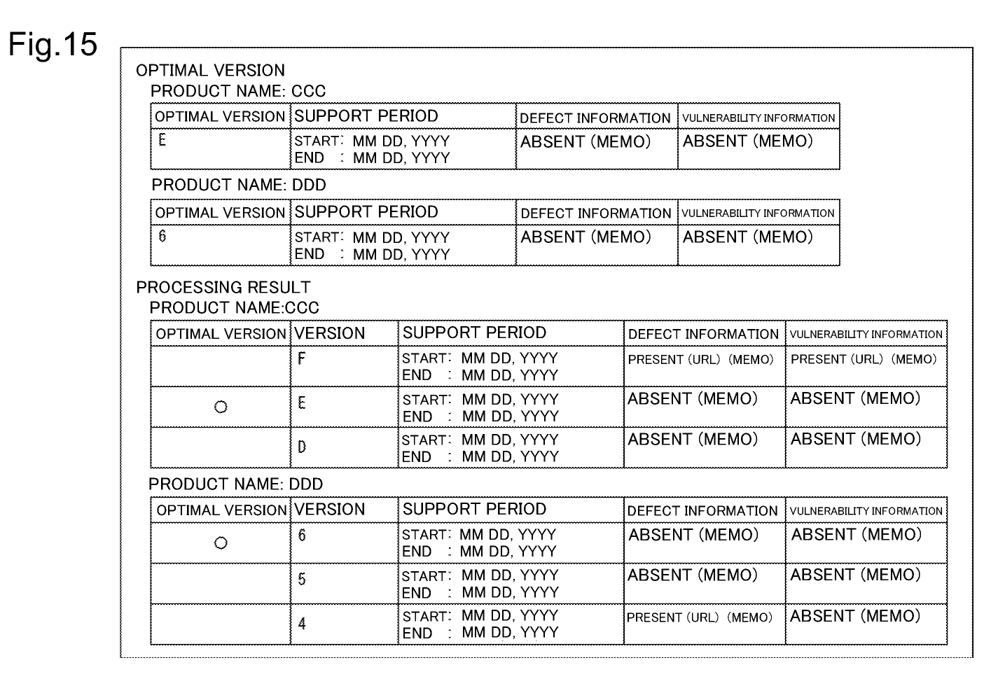

FIG. 15 is a diagram illustrating an example of the display of the version selection result by the display unit 120 in a case where there is a related product.

In the example of FIG. 15, it is assumed that a product CCC (a product with a product name: CCC) is a version upgrade target product, and a product DDD is a related product of the product CCC.

The display unit 120 displays optimal versions of the product CCC and the product DDD, and also displays candidates for version upgrade for the product CCC and the product DDD.

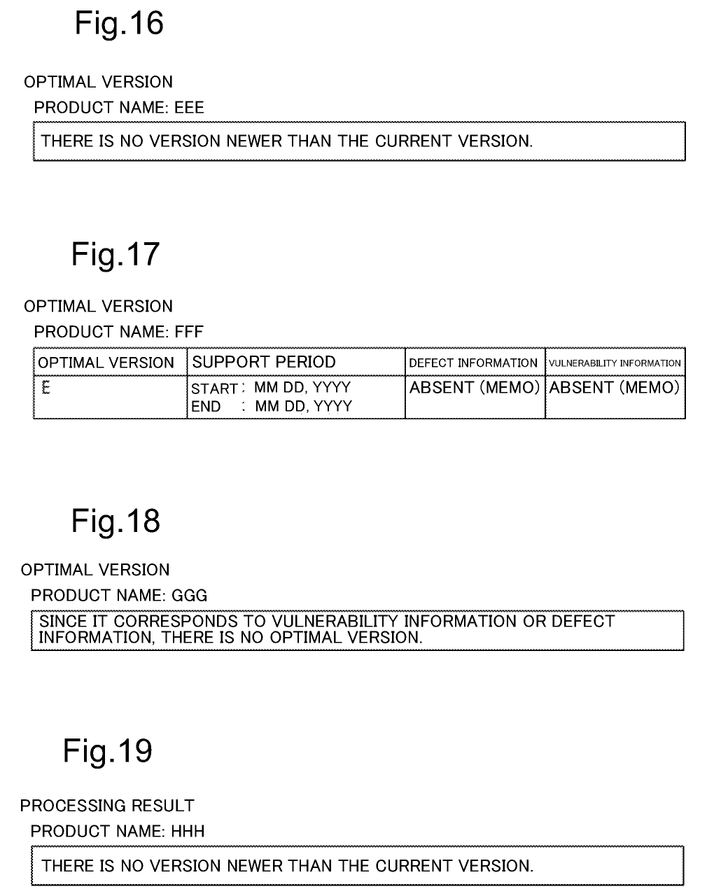

FIG. 16 is a diagram illustrating a display example of the optimal version by the display unit 120 in a case where there is no version newer than the current version.

In this case, the display unit 120 displays that there is no version newer than the current version.

FIG. 17 is a diagram illustrating a display example of the optimal version by the display unit 120 in a case where there is a version newer than the current version and there is no vulnerability information and no defect information.

In this case, the determination unit 192 selects the latest version among corresponding versions as the optimal version.

The display unit 120 displays the optimal version, the support period of the optimal version, absence of the defect information, and absence of the vulnerability information.

FIG. 18 is a diagram illustrating a display example of the optimal version by the display unit 120 in a case where there is no version that is newer than the current version and that has no vulnerability information and no defect information.

In this case, the display unit 120 displays that there is no optimal version since versions of the candidate for the version upgrade have the vulnerability information or the defect information.

FIG. 19 is a diagram illustrating a display example of a processing result (list of candidates for version upgrade) by the display unit 120 in a case where there is no version newer than the current version.

In this case, the display unit 120 displays that there is no version newer than the current version.

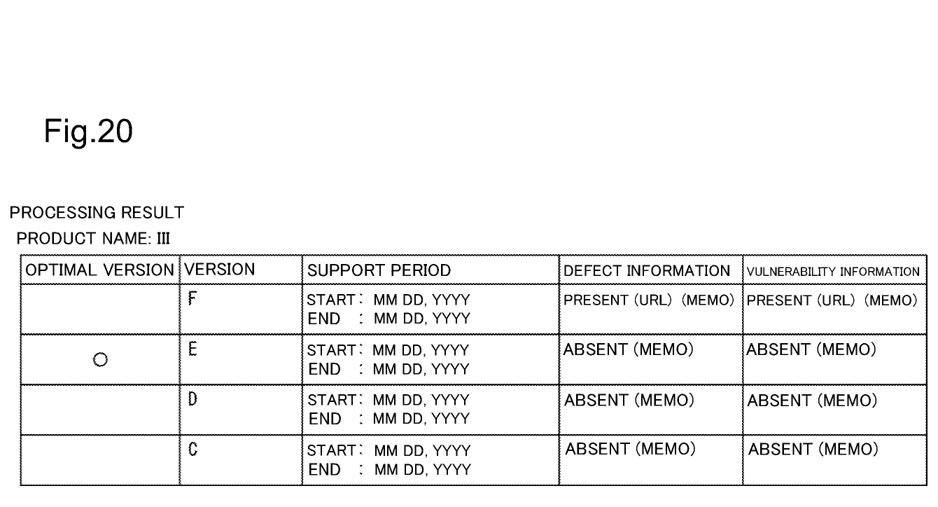

FIG. 20 is a diagram illustrating a display example of the processing result by the display unit 120 in a case where there is a version that is newer than the current version and whose version upgrade period is included within the support period.

In this case, the display unit 120 displays the support period, the defect information, and the vulnerability information for each version that is newer than the current version and whose version upgrade period is included within the support period, and displays the optimal version.

A method by which the version presentation device 100 acquires information such as the version information, the defect information, and the vulnerability information on the product is not limited to a method for receiving human input.

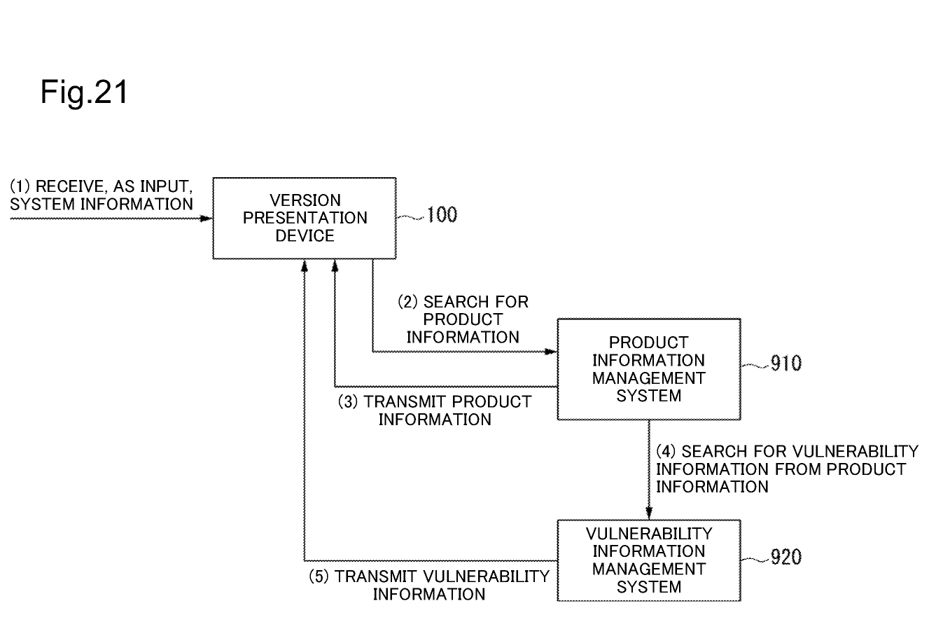

FIG. 21 is a diagram illustrating an example of acquisition of information by the version presentation device 100.

In the example of FIG. 21, the version presentation device 100 is configured to be capable of communicating with each of a product information management system ((Infrastructure as Code; IaC) system) 910 and a vulnerability information management system 920.

The product information management system 910 is a system that manages product information by IaC.

The vulnerability information management system 920 is, for example, a system that provides vulnerability information, such as Japan Vulnerability Notes (JVN).

In the example of FIG. 21, the version presentation device 100 acquires the information by the following procedure.
(1) The version presentation device 100 receives an input of system information such as information on a system as a version management target.
(2) The version presentation device 100 searches for product information stored in the product information management system 910, based on the input system information. For example, the version presentation device 100 may search for the product information by using a product name included in the system information as a key.
(3) The product information management system 910 transmits the product information of the search result to the version presentation device 100. For example, the product information management system 910 transmits the product information including the version information and defect information on the product to the version presentation device 100.
(4) The product information management system 910 searches for the vulnerability information about the product for which the search is performed from the vulnerability information stored in the vulnerability information management system 920. The product information management system 910 may perform the search, or the version presentation device 100 may perform the search using the product information acquired from the product information management system 910.
(5) The vulnerability information management system 920 transmits the vulnerability information of the search result to the version presentation device 100.

As described above, the information acquisition unit 191 acquires the product information, the vulnerability information, and the defect information.

The determination unit 192 determines the optimal version at the time of performing version upgrade among the versions of the version upgrade target product by using the obtained product information, vulnerability information, and defect information, and information on the version upgrade target product.

The presentation unit 193 presents the determined optimal version.

According to the version presentation device 100, it is possible to select a version in consideration of a defect and vulnerability of a product by referring to the vulnerability information and the defect information.

The determination unit 192 determines a version of which the scheduled version upgrade date of the version upgrade target product is included within the support period as a version of a candidate for the version upgrade, and determines the latest version among versions each being the candidate for the version upgrade and having no vulnerability information and no defect information as the optimal version.

According to the version presentation device 100, it is possible to propose, as the optimal version, a version of which the scheduled version upgrade date is included in the support period and that has no vulnerability information and no defect information.

The presentation unit 193 presents the optimal version and the version of the candidate for the version upgrade.

According to the version presentation device 100, it is possible to exclude a version having the vulnerability information or the defect information from optimal versions and present the version as a version of the candidate for the version upgrade. According to the version presentation device 100, it is possible to present a wider range of options to the user while proposing a version having no vulnerability information and no defect information as the optimal version.

The determination unit 192 determines the optimal version of the related product that is a product having a version dependency relationship with the version upgrade target product.

The presentation unit 193 presents the optimal version of the version upgrade target product and the optimal version of the related product.

According to the version presentation device 100, it is possible to propose a version also for the related product.

The determination unit 192 determines, for the related product, a version of which the scheduled version upgrade date is included within the support period as the version of the candidate for version upgrade. The determination unit 192 determines, as the optimal version of the version upgrade target product, a latest version among the versions of the version upgrade target product, the latest version being included in versions of a candidate for the version upgrade of the version upgrade target product and having no vulnerability information and no defect information and having a version of the related product relevant to the latest version, the version being included in versions of the candidate for the version upgrade of the related product and having no vulnerability information and no defect information, and determines, as the optimal version of the related product, a latest version among versions of the related product relevant to the optimal version of the version upgrade target product, the latest version being included in the versions of the candidate for the version upgrade of the related product and having no vulnerability information and no defect information.

According to the version presentation device 100, it is possible to propose a version having no vulnerability information and no defect information as the optimal version for each of the version upgrade target product and the related product.

### Second Example Embodiment

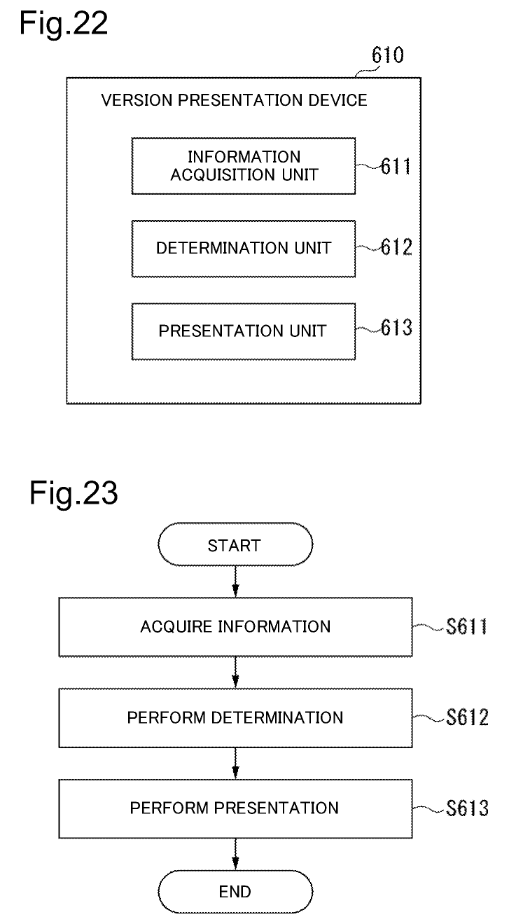

FIG. 22 is a diagram illustrating an example of a configuration of a version presentation device according to at least one example embodiment. In the configuration illustrated in FIG. 22, a version presentation device 610 includes an information acquisition unit 611, a determination unit 612, and a presentation unit 613.

With this configuration, the information acquisition unit 611 acquires product information, vulnerability information, and defect information. The determination unit 612 determines the optimal version at the time of performing version upgrade among versions of a version upgrade target product by using the obtained product information, vulnerability information, and defect information, and information on the version upgrade target product.

The presentation unit 613 presents the determined optimal version.

The information acquisition unit 611 corresponds to an example of an information acquisition means. The determination unit 612 corresponds to an example of a determination means. The presentation unit 613 corresponds to an example of a presentation means.

According to the version presentation device 610, it is possible to select a version in consideration of a defect and vulnerability of a product by referring to the vulnerability information and the defect information.

### Third Example Embodiment

FIG. 23 is a diagram illustrating an example of processing in a version presentation method according to at least one example embodiment. The version presentation method illustrated in FIG. 23 includes acquiring information (step S611), performing determination (step S612), and performing presentation (step S613).

In the acquiring information (step S611), a computer acquires product information, vulnerability information, and defect information.

In the performing determination (step S612), the computer determines the optimal version at the time of performing version upgrade among versions of a version upgrade target product by using the obtained product information, vulnerability information, and defect information, and information on the version upgrade target product.

In the performing presentation (step S613), the computer presents the determined optimal version.

According to the version presentation method illustrated in FIG. 23, it is possible to select a version in consideration of a defect and vulnerability of a product by referring to the vulnerability information and the defect information.

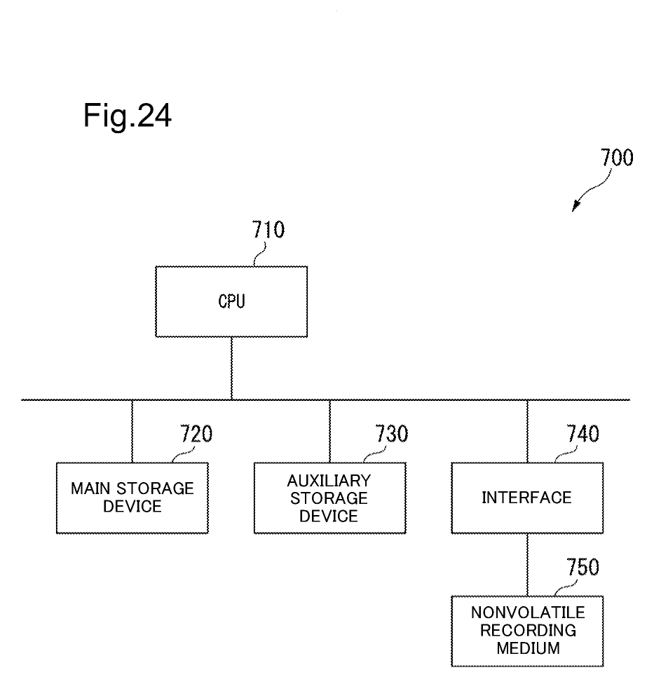

FIG. 24 is a diagram illustrating an example of a configuration of a computer according to at least one example embodiment.

In the configuration illustrated in FIG. 24, a computer 700 includes a CPU 710, a main storage device 720, an auxiliary storage device 730, an interface 740, and a nonvolatile recording medium 750.

One or more of the version presentation device 100 and the version presentation device 610 described above or a part thereof may be implemented in the computer 700. In this case, the operation of each processing unit described above is stored in the auxiliary storage device 730 in the form of a program. The CPU 710 reads the program from the auxiliary storage device 730, loads the program in the main storage device 720, and executes the above processing according to the program. Furthermore, the CPU 710 secures a storage area related to each of the above-described storage units in the main storage device 720 according to the program. Communication between each device and another device is executed by the interface 740 having a communication function and performing communication under the control of the CPU 710. The interface 740 has a port for the nonvolatile recording medium 750, and reads information from the nonvolatile recording medium 750 and writes information to the nonvolatile recording medium 750.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily store the program in the main storage device 720 or the auxiliary storage device 730 and execute the program.

A program for executing all or part of the processing performed by the version presentation device 100 and the version presentation device 610 may be recorded in a computer-readable recording medium, and a computer system may be caused to read and execute the program recorded in the recording medium, whereby the processing by each unit may be performed. The “computer system” herein includes an Operating System (OS) and hardware such as peripheral devices.

The “computer-readable recording medium” refers to a portable medium such as a flexible disk, a magneto-optical disk, a Read Only Memory (ROM), and a Compact Disc Read Only Memory (CD-ROM), and a storage device such as a hard disk built in the computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above-described example embodiments may also be described as the following supplementary notes, but are not limited to the following supplementary notes.

### Supplementary Note 1

A version presentation device including

an information acquisition means for acquiring product information, vulnerability information, and defect information,

a determination means for determining an optimal version at time of performing version upgrade among versions of a version upgrade target product by using the product information, the vulnerability information, and the defect information obtained, and information on the version upgrade target product, and

a presentation means for presenting the optimal version determined.

### Supplementary Note 2

The version presentation device according to Supplementary Note 1, in which

the determination means determines a version of which a scheduled version upgrade date of the version upgrade target product is included within a support period as a version of a candidate for version upgrade, and determines a latest version among versions each being the candidate for the version upgrade and having no vulnerability information and no defect information as the optimal version.

### Supplementary Note 3

The version presentation device according to Supplementary Note 1 or Supplementary Note 2, in which

the presentation means presents the optimal version and the version of the candidate for the version upgrade.

### Supplementary Note 4

The version presentation device according to any one of Supplementary Notes 1 to 3, in which

the determination means determines an optimal version of a related product that is a product having a version dependency relationship with the version upgrade target product, and

the presentation means presents the optimal version of the version upgrade target product and the optimal version of the related product.

### Supplementary Note 5

The version presentation device according to Supplementary Note 4, in which

the determination means determines, for the related product, a version of which a scheduled version upgrade date of the version upgrade target product is included within a support period as a version of a candidate for version upgrade,

determines, as the optimal version of the version upgrade target product, a latest version among the versions of the version upgrade target product, the latest version being included in versions of a candidate for the version upgrade of the version upgrade target product and having no vulnerability information and no defect information and having a version of the related product relevant to the latest version, the version being included in versions of the candidate for the version upgrade of the related product and having no vulnerability information and no defect information, and determines, as the optimal version of the related product, a latest version among versions of the related product relevant to the optimal version of the version upgrade target product, the latest version being included in the versions of the candidate for the version upgrade of the related product and having no vulnerability information and no defect information.

### Supplementary Note 6

A version presentation method including,

by a computer,

acquiring product information, vulnerability information, and defect information,

determining an optimal version at time of performing version upgrade among versions of a version upgrade target product by using the product information, the vulnerability information, and the defect information obtained, and information on the version upgrade target product, and

presenting the optimal version determined.

### Supplementary Note 7

A program for causing

a computer to execute:

acquiring product information, vulnerability information, and defect information;

determining an optimal version at time of performing version upgrade among versions of a version upgrade target product by using the product information, the vulnerability information, and the defect information obtained, and information on the version upgrade target product; and

presenting the optimal version determined.

It is also possible to cause supplementary notes relevant to Supplementary Notes 2 to 5 to be dependent on Supplementary Notes 6 and 7.

There is a case where selection of a version of a product used in a system or the like is performed. If it is possible to select a version in consideration of a defect and vulnerability of a product, it is expected that a more appropriate product can be selected.

An example of an effect of the aspects of the present disclosure is that it is possible to select a version in consideration of a defect and vulnerability of a product.

1. A version presentation device comprising:
one or more memories storing instructions; and
one or more processors configured to execute the instructions to:
acquire product information, vulnerability information, and defect information;
determine an optimal version at time of performing version upgrade among versions of a version upgrade target product by using the product information, the vulnerability information, and the defect information obtained, and information on the version upgrade target product; and
present the optimal version determined.

2. The version presentation device according to claim 1, wherein the one or more processors are configured to execute the instructions to:
determine a version of which a scheduled version upgrade date of the version upgrade target product is included within a support period as a version of a candidate for version upgrade; and
determine a latest version among versions each being the candidate for the version upgrade and having no vulnerability information and no defect information as the optimal version.

3. The version presentation device according to claim 1, wherein the one or more processors are configured to execute the instructions to:
present the optimal version and the version of the candidate for the version upgrade.

4. The version presentation device according to claim 1, wherein the one or more processors are configured to execute the instructions to:
determine an optimal version of a related product that is a product having a version dependency relationship with the version upgrade target product; and
present the optimal version of the version upgrade target product and the optimal version of the related product.

5. The version presentation device according to claim 4, wherein the one or more processors are configured to execute the instructions to:
determine, for the related product, a version of which a scheduled version upgrade date of the version upgrade target product is included within a support period as a version of a candidate for version upgrade;
determine, as the optimal version of the version upgrade target product, a latest version among the versions of the version upgrade target product, the latest version being included in versions of a candidate for the version upgrade of the version upgrade target product and having no vulnerability information and no defect information and having a version of the related product relevant to the latest version, the version being included in versions of the candidate for the version upgrade of the related product and having no vulnerability information and no defect information; and
determine, as the optimal version of the related product, a latest version among versions of the related product relevant to the optimal version of the version upgrade target product, the latest version being included in the versions of the candidate for the version upgrade of the related product and having no vulnerability information and no defect information.

6. A version presentation method comprising,
by a computer,
acquiring product information, vulnerability information, and defect information,
determining an optimal version at time of performing version upgrade among versions of a version upgrade target product by using the product information, the vulnerability information, and the defect information obtained, and information on the version upgrade target product, and
presenting the optimal version determined.

7. A non-transitory recording medium storing a program for causing
a computer to execute:
acquiring product information, vulnerability information, and defect information;
determining an optimal version at time of performing version upgrade among versions of a version upgrade target product by using the product information, the vulnerability information, and the defect information obtained, and information on the version upgrade target product; and
presenting the optimal version determined.
